(19) United States
(12) Patent Application Publication
(10) Pub. No.: US 2012/0303405 A1
(43) Pub. Date: Nov. 29, 2012

(54) METHOD AND SYSTEM FOR WEB-BASED SALON SERVICES

(76) Inventor: Sarah BRUNO, Davidsonville, MD (US)

(21) Appl. No.: 13/458,819

(22) Filed: Apr. 27, 2012

Related U.S. Application Data
(60) Provisional application No. 61/479,589, filed on Apr. 27, 2011.

(51) Int. Cl. G06Q 10/10

(52) U.S. Cl. 705/7.19

(57) ABSTRACT

Presented are web-based methods and systems for providing salon services to individuals, while at the same providing child care and/or child educational services for the individuals' children. Further presented are web-based methods and systems for providing salon services to individuals, while also providing opportunities for the individuals to improve their physical fitness levels, healthy eating habits and nutrition awareness. Further presented are web-based methods and systems for providing salon services to individuals, while also allowing them to take care of work-related activities, such as checking e-mail and/or attending web-based meetings, among other computer-related activities, while waiting for an appointment at the salon.

This application claims priority from U.S. Provisional Application No. 61/479,589, filed on Apr. 27, 2011, titled “Method and System for Web-based Salon Services,” which is incorporated herein by reference in its entirety.

### BACKGROUND OF THE INVENTION

1. Field of Invention

Aspects of the present invention relate to methods and systems for providing web-based services. More particularly, aspects of the current invention related to methods and systems for providing web-based salon services.

2. Description of Related Art

Currently, the salon concept of providing services to individuals is failing to keep up with individuals' busy lifestyles. People who desire to avail themselves of salon services today have a multitude of additional work and family-related responsibilities, and it is difficult for them to devote time to visit a salon without setting aside their other responsibilities or spending money to hire a sitter or imposing on a family member or friend to watch the children. In addition, people are becoming increasingly aware that physical fitness, healthy eating habits and education on proper nutrition are becoming more and more important with respect to their lifestyles. Finding the time to devote to their health is thus becoming yet another demand on their time.

There is a need in the art for web-based methods and systems for providing salon services to individuals, while at the same providing child care and/or child educational services for their children, thereby eliminating the need to hire babysitters or asking family members to look after the children. There is another need in the art for web-based methods and systems for providing salon services to individuals while also providing opportunities for the individuals to improve their physical fitness levels, healthy eating habits and nutrition awareness. There is yet a further need in the art for web-based methods and systems for providing salon services to individuals while also allowing them to take care of work-related activities, such as checking e-mail and attending web-based meetings, among other activities, while waiting for an appointment, a fitness class or course on healthy nutrition, for example.

### SUMMARY OF THE INVENTION

Aspects of the present invention solve the above-identified needs, as well as others, by setting forth web-based methods and systems for providing salon services to individuals, while at the same providing child care and/or child educational services for their children. Aspects of the present invention further set forth web-based methods and systems for providing salon services to individuals, while also providing opportunities for the individuals to improve their physical fitness levels, healthy eating habits and nutrition awareness. Aspects of the present invention further set forth web-based methods and systems for providing salon services to individuals, while also allowing them to take care of work-related activities, such as checking e-mail and/or attending web-based meetings, among other computer-related activities, while waiting for an appointment, a fitness class or course on healthy nutrition, for example.

Additional advantages and novel features of the invention will be set forth in part in the description that follows, and in part will become more apparent to those skilled in the art upon examination of the following or upon learning by practice of the invention.

### BRIEF DESCRIPTION OF THE DRAWINGS

Various example aspects of the systems and methods will be described in detail, with reference to the following figures, wherein:

FIG. 1 presents an example flow diagram of functions performed in accordance with aspects of the present invention;

FIG. 2 presents an example system diagram of various hardware components and other features, for use in accordance with aspects of the present invention; and

FIG. 3 is a block diagram of various example system components, for use in accordance with aspects of the present invention.

### DETAILED DESCRIPTION

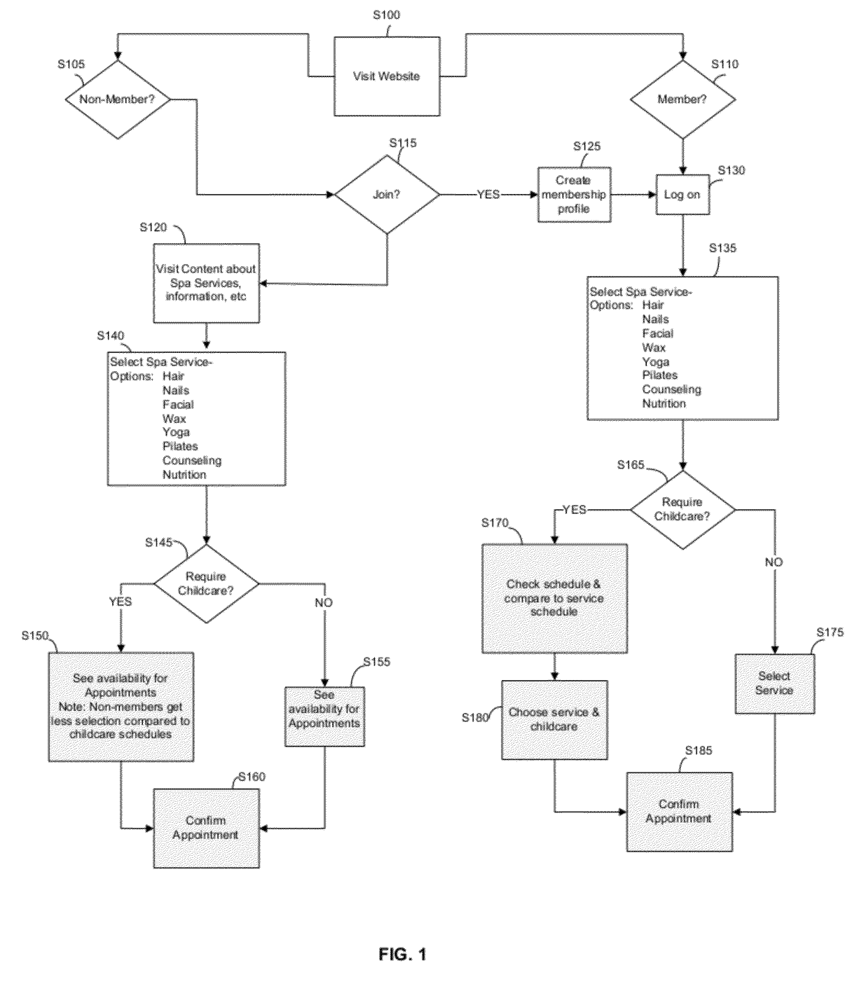

Referring now to FIG. 1, therein shown is an example flow diagram of a method of providing web-based salon services in accordance with aspects of the present invention. The method starts upon visiting the salon's website at S100. According to various aspects, a determination is made of whether the individual visiting the salon's website at S100 is a member of the salon or spa. If the individual is a member at S110, the individual may log on as a member at S130. On the other hand, if the individual visiting the salon's website at S100 is not a member at S105, then the individual may elect to either become a member at S115 or visit content regarding the salon/spa services provided at S120. According to various aspects, if the individual is not a member and elects to join the salon at S115, then a membership profile may be created for the individual at S125, and the individual may then log on to the salon as a member at S130, as discussed above. According to various aspects, if the individual declines to join at S115, then although the individual may still be permitted to visit content about the salon services at S120, the individual may have less salon/spa services to choose from than a member, for example.

According to various aspects, when the individual who is a member logs on the service at S130, the individual may select any desired spa services from a panel of possible services at S135, where the services may include regular salon services such as hair treatment, nails, facials and massages, and the like, may also include yoga and pilates, among other like fitness classes, may provide exercise room facilities useable at any time, as well as courses on nutrition and other services, such a counseling, for example. According to various aspects, counseling and nutrition services may be available either via a telephone communication with a counselor and/or via a personal meeting with a counselor, for example. According to various aspects, upon selecting the appropriate services at S135, the individual may indicate whether child care services are required at S165. For example, child care services may include classes such as painting, music or reading, and may be geared towards children of different age groups. It should be noted that child care services may also be geared to children of a particular age group, and/or may include any educational, gaming and/or sporting activities, for example.

According to various aspects, when the individual indicates that child care services are required at S165, the individual may check their own schedule and compare their own schedule to the selected service schedule, for example, at S170. For example, if the individual needs hair treatment and child care between 5 pm and 6 pm, the individual may check the salon's website or brochure at S170 to determine whether child care and hair treatment are available in the desired time slot. According to various aspects, when the individual has checked the available child care and service schedule, the individual may then select both the individual's service such as hair treatment and child care at S180. Once selected, the services and child care appointments may be confirmed at S185, and provided to the individual accordingly. Child care services may be provided only if the individual is in the facility and obtaining a salon/spa service, in accordance with one aspect of the current invention. If at S165, a determination is made that child care is not required, then the individual may proceed directly to selecting a service such as, for example, a facial treatment at S175, and then confirming the appointment at S185, at which point the service is provided to the individual according to the individual's desired schedule. In accordance with one aspect, individuals that are members of the salon or salon website may have access to more services, more child care activities, higher priority for time slots reserved for services/child care, and may also have access to discounted services and/or coupons for discounts as compared to non-members, for example.

According to various aspects, if the individual declines to join the salon as a member at S115, the individual may be permitted to visit content about the salon and the services provided therein at S120 and may also view and select one or more of the services available at the salon at S140. For example, although non-members may view and select services at the salon at S140 including child care, the selection of services for non-members, as well as the availability of prime time slots, may be fewer than for members. According to various aspects, upon selecting a given services at S140, the individual may also indicate whether child care services are required at S145. For example, child care services may include classes such as painting, music or reading, and may be geared towards children of different age groups. It should be noted that child care services may also be geared to children of a particular age group, and/or may include any educational, gaming and/or sporting activities, for example.

According to various aspects, when the individual indicates that child care services are required at S145, the individual may check their own schedule and compare their own schedule to the selected service schedule, for example, at S150. For example, if the individual needs hair treatment and child care between 5 pm and 6 pm, the individual may check the salon's website or brochure at S150 to determine whether child care and hair treatment are available in the desired time slot. According to various aspects, when the individual has checked the available child care and service schedule, the individual may then select both the individual's service such as hair treatment and child care. Once selected, the services and child care appointments may be confirmed at S160, and provided to the individual accordingly. Child care services may be provided only if the individual is in the facility and obtaining a salon/spa service, in accordance with one aspect of the current invention. If at S145, a determination is made that child care is not required, then the individual may proceed directly to viewing the list of available appointments for services and selecting a service such as, for example, a facial treatment at S155, and then confirming the appointment at S160, at which point the service is provided to the individual according to the individual's desired schedule.

Upon arrival at the salon/spa, and while waiting for an appointment in the waiting room, an individual may have the opportunity to check e-mail or perform other computer activities on one or more computers as well as wi-fi provided in the waiting room area.

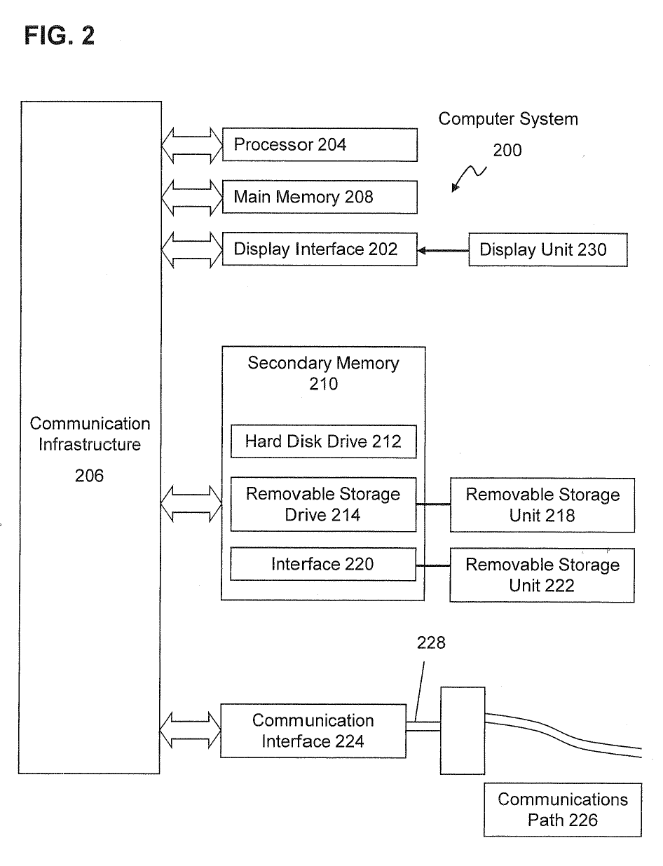

In some variations, aspects of the present invention may be directed toward one or more computer systems capable of carrying out the functionality described herein. An example of such a computer system 200 is shown in FIG. 2.

Computer system 200 includes one or more processors, such as processor 204. The processor 204 is connected to a communication infrastructure 206 (e.g., a communications bus, cross-over bar, or network). Various software aspects are described in terms of this example computer system. After reading this description, it will become apparent to a person skilled in the relevant art(s) how to implement the invention using other computer systems and/or architectures.

Computer system 200 can include a display interface 202 that forwards graphics, text, and other data from the communication infrastructure 206 (or from a frame buffer not shown) for display on a display unit 230. Computer system 200 also includes a main memory 208, preferably random access memory (RAM), and may also include a secondary memory 210. The secondary memory 210 may include, for example, a hard disk drive 212 and/or a removable storage drive 214, representing a floppy disk drive, a magnetic tape drive, an optical disk drive, etc. The removable storage drive 214 reads from and/or writes to a removable storage unit 218 in a well-known manner. Removable storage unit 218, represents a floppy disk, magnetic tape, optical disk, etc., which is read by and written to removable storage drive 214. As will be appreciated, the removable storage unit 218 includes a computer usable storage medium having stored therein computer software and/or data.

In alternative aspects, secondary memory 210 may include other similar devices for allowing computer programs or other instructions to be loaded into computer system 200. Such devices may include, for example, a removable storage unit 222 and an interface 220. Examples of such may include a program cartridge and cartridge interface (such as that found in video game devices), a removable memory chip (such as an erasable programmable read only memory (EPROM), or programmable read only memory (PROM)) and associated socket, and other removable storage units 222 and interfaces 220, which allow software and data to be transferred from the removable storage unit 222 to computer system 200.

Computer system 200 may also include a communications interface 224. Communications interface 224 allows software and data to be transferred between computer system 200 and external devices. Examples of communications interface 224 may include a modem, a network interface (such as an Ethernet card), a communications port, a Personal Computer Memory Card International Association (PCMCIA) slot and card, etc. Software and data transferred via communications interface 224 are in the form of signals 228, which may be electronic, electromagnetic, optical or other signals capable of being received by communications interface 224. These signals 228 are provided to communications interface 224 via a communications path (e.g., channel) 226. This path 226 carries signals 228 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 214, a hard disk installed in hard disk drive 212, and signals 228. These computer program products provide software to the computer system 200. The invention is directed to such computer program products.

Computer programs (also referred to as computer control logic) are stored in main memory 208 and/or secondary memory 210. Computer programs may also be received via communications interface 224. Such computer programs, when executed, enable the computer system 200 to perform the features of the present invention, as discussed herein. In particular, the computer programs, when executed, enable the processor 210 to perform the features of the present invention. Accordingly, such computer programs represent controllers of the computer system 200.

In an aspect where the invention is implemented using software, the software may be stored in a computer program product and loaded into computer system 200 using removable storage drive 214, hard drive 212, or communications interface 220. The control logic (software), when executed by the processor 204, causes the processor 204 to perform the functions of the invention as described herein. In another aspect, the invention is implemented primarily in hardware using, for example, hardware components, such as application specific integrated circuits (ASICs). Implementation of the hardware state machine so as to perform the functions described herein will be apparent to persons skilled in the relevant art(s).

In yet another aspect, the invention is implemented using a combination of both hardware and software.

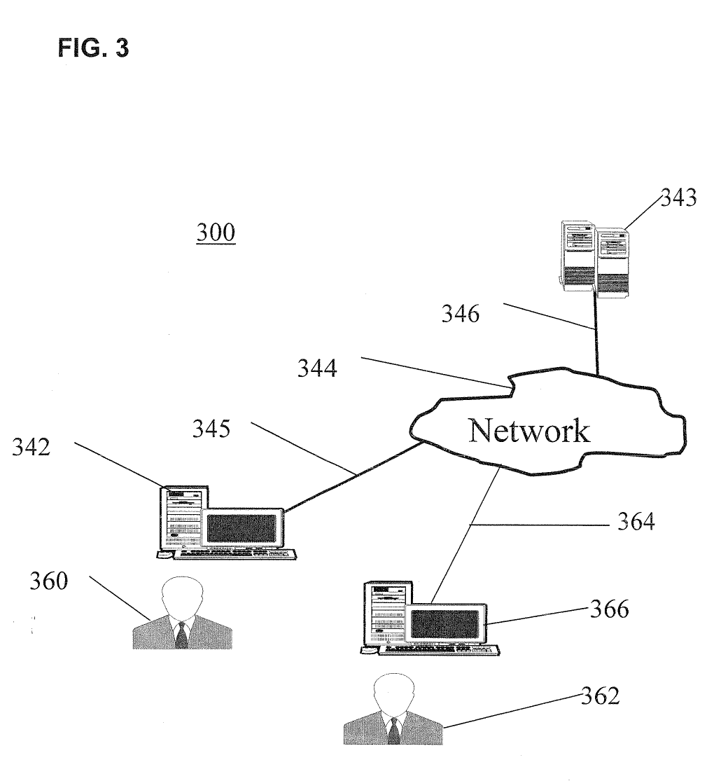

FIG. 3 shows a communication system 300 involving use of various features in accordance with aspects of the present invention. The communication system 300 includes one or more assessors 360, 362 (also referred to interchangeably herein as one or more “users”) and one or more terminals 342, 366 accessible by the one or more accessors 360, 362. In one aspect, operations in accordance with aspects of the present invention is, for example, input and/or accessed by an accessor 360 via terminal 342, such as personal computers (PCs), minicomputers, mainframe computers, microcomputers, telephonic devices, or wireless devices, such as personal digital assistants (“PDAs”) or a hand-held wireless devices coupled to a remote device 343, such as a server, PC, minicomputer, mainframe computer, microcomputer, or other device having a processor and a repository for data and/or connection to a repository for data, via, for example, a network 344, such as the Internet or an intranet, and couplings 345, 364. The couplings 345, 364 include, for example, wired, wireless, or fiberoptic links. In another aspect, the method and system of the present invention operate in a stand-alone environment, such as on a single terminal.

While this invention has been described in conjunction with the example aspects outlined above, various alternatives, modifications, variations, improvements, and/or substantial equivalents, whether known or that are or may be presently unforeseen, may become apparent to those having at least ordinary skill in the art. Accordingly, the example aspects of the invention, as set forth above, are intended to be illustrative, not limiting. Various changes may be made without departing from the spirit and scope of the invention. Therefore, the invention is intended to embrace all known or later-developed alternatives, modifications, variations, improvements, and/or substantial equivalents.

What is claimed is:

1. A computer-assisted method of providing salon services, the computer including a processor, the method comprising:
providing a selection of at least one selected from a group consisting of a salon service and a child care option to a user via the processor;
receiving a selection of one of the salon service and the child care option from the user; and
scheduling the selected one of the salon service and the child care option;
wherein the selected one of the salon service and the child care option is provided to the user as scheduled.

2. The method of claim 1, wherein the user is one selected from a group consisting of a member and a non-member.

3. The method of claim 2, wherein when the user is a member, the user has more salon services and child care options to select from than when the user is a non-member.

4. The method of claim 1, wherein the salon service comprises at least one selected from a group consisting of a hair treatment, a nail treatment, a facial treatment, a fitness class, a yoga class, a wax treatment, a counseling session and a nutrition education session.

5. The method of claim 1, wherein the child care option comprises at least one selected from a group consisting of painting, music, a game, a fitness activity and reading.

6. The method of claim 1, wherein the child care option is for children of a specific age range.

7. A system for providing salon services, the system comprising:
a module for providing a selection of at least one selected from a group consisting of a salon service and a child care option to a user via the processor;
a module for receiving a selection of one of the salon service and the child care option from the user; and
a module for scheduling the selected one of the salon service and the child care option;
wherein the selected one of the salon service and the child care option is provided to the user as scheduled.

8. The method of claim 7, wherein the user is one selected from a group consisting of a member and a non-member.

9. The method of claim 7, wherein the salon service comprises at least one selected from a group consisting of a hair treatment, a nail treatment, a facial treatment, a fitness class, a yoga class, a wax treatment, a counseling session and a nutrition education session.

10. The method of claim 7, wherein the child care option comprises at least one selected from a group consisting of painting, music, a game, a fitness activity and reading.

11. The method of claim 7, wherein the child care option is for children of a specific age range.

12. A system for providing salon services, the system comprising:
a processor;
a user interface functioning via the processor; and
a repository accessible by the processor; wherein
a selection of at least one selected from a group consisting of a salon service and a child care option is provided to a user via the processor;
a selection of one of the salon service and the child care option is received from the user;
the selected one of the salon service and the child care option is scheduled; and
the selected one of the salon service and the child care option is provided to the user as scheduled.

13. The system of claim 12, wherein the processor is housed on a terminal selected from a group consisting of a personal computer, a minicomputer, a main frame computer, a microcomputer, a hand held device, and a telephonic device.

14. The system of claim 12, wherein the processor is housed on a server selected from a group consisting of a personal computer, a minicomputer, a microcomputer, and a main frame computer.

15. A computer program product comprising a computer usable medium having control logic stored therein for causing a computer to exchange user-generated community information, the control logic comprising:
computer readable program code means for providing a selection of at least one selected from a group consisting of a salon service and a child care option to a user via the processor;
computer readable program code means for receiving a selection of one of the salon service and the child care option from the user; and
computer readable program code means for scheduling the selected one of the salon service and the child care option;
wherein the selected one of the salon service and the child care option is provided to the user as scheduled.
